(19) United States
(12) Patent Application Publication
(10) Pub. No.: US 2009/0095564 A1
(43) Pub. Date: Apr. 16, 2009

(54) Apparatus for controlling vehicle

(75) Inventor: Tsutomu Tashiro, Munchen (DE)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/287,776

(22) Filed: Oct. 14, 2008

(30) Foreign Application Priority Data
Oct. 15, 2007 (JP) 2007-268325

(51) Int. Cl. B62D 5/04

(52) U.S. Cl. 180/443

(57) ABSTRACT

Tire-uniformity components may generate a rotating force on the vehicle, when the vehicle is in a turning movement. The rotating force may spoil or deteriorate a turning performance of the vehicle. The controller controls a motor of an electric power steering system to modulate an assist torque acting on steerable wheels in accordance with the tire-uniformity components. The assist torque is modulated in the same direction as the rotating force. As a result, it is possible to suppress a deterioration of the turning performance of the vehicle.

### CROSS REFERENCE TO RELATED APPLICATION

This application is based on Japanese Patent Application No. 2007-268325 filed on Oct. 15, 2007, the contents of which are incorporated herein by reference in its entirety.

### FIELD OF THE INVENTION

The present invention relates to an apparatus for controlling vehicle, especially for controlling turning movement of the vehicle.

### BACKGROUND OF THE INVENTION

JP-A-H08-132831 discloses an apparatus for determining a tire related conditions such as air pressure in a tire, an abrasion amount of a tire, and vibrating modes of a tire, e.g., a standing wave mode based on a tire-uniformity component. The tire-uniformity component is a variable which may be indicated by a fluctuation on rotation speed of a wheel during a rotation of the wheel. The tire-uniformity component can be obtained by processing a signal indicative of rotation speed of a wheel.

One embodiment of a practical application of the tire-uniformity components and a method for calculating the tire-uniformity components is described in IP-A-H08-132831, which is incorporated herein by reference. Additionally, a brief description of the tire-uniformity components is provided below.

### SUMMARY OF THE INVENTION

Usually, a tire for vehicle is manufactured by winding and wrapping steel wires and rubber layers. A tire has an outer profile close to a perfect circle, but actually being not perfect circle. Therefore, a tire has unbalances in some physical aspects such as a strength and density along the circumference of the tire. Such physical unbalances may destroy the uniformity of tire. In addition, a wheel for a vehicle has other components such as a rim, bolts and hub, which may also obtain unbalances on a wheel. In order to decrease the unbalances on a wheel, a dynamic balance is adjusted for each wheel after assembling a tire on a rim by attaching a balancer weight on each wheel.

However, even if a balancer weight is attached, it is impossible to perfectly cancel a weight distribution along the circumference of a wheel. For this reason, when a vehicle cruises at a constant speed, each wheel still generates a very small fluctuation on rotation speed due to physical unbalances such as an unbalance of weight distribution on a tire. The rotation speed fluctuation represents the tire-uniformity components. Therefore, the tire-uniformity components observed on the rotation speed includes the unbalances on not only a tire but also other components mechanically connected with a wheel. The rotation speed fluctuation can be observed as a cyclic wave form having a maximum value, a minimum value, and a cyclic period corresponding to one rotation of a wheel. The rotation speed fluctuation representing the tire-uniformity component may be observed as a wave form close to a sine curve.

Each of a plurality of wheels on a vehicle usually generates unique fluctuation. For example, the rotation speed fluctuations of wheels are different in phase. Such phase differences may be varied by movements of a vehicle such as turning movement, acceleration and deceleration, and outside disturbances such as a disturbance from a road surface. For example, the rotation speed fluctuations on an outside front wheel and an inside rear wheel are widely varied between an in-phase relation and an anti-phase relation.

In case that a vehicle is turning, the rotation speed fluctuations on the outside front wheel and the inside rear wheel may become an anti-phase relation. In case that the phase relation is in an anti-phase relation, and the rotation speed of the outside front wheel is greater than the rotation speed of the inside rear wheel, then, the vehicle body receives force that additionally rotates the vehicle body in the turning direction. The force may be called as a turn promoting force. In case that the phase relation is in an anti-phase relation, and the rotation speed of the outside front wheel is smaller than the rotation speed of the inside rear wheel, then, the vehicle body receives force that rotates the vehicle body in opposite to the turning direction. The force may be called as a turn preventing force. Since the phase relation and a level of the rotation speed fluctuation are varied, the force that rotates the vehicle body is also changed in response to the rotation speed fluctuations on wheels. The turn promoting force and the turn preventing force may alternately act on the vehicle body. Such a changing force may deteriorate a turning performance of the vehicle.

In view of the foregoing problems, it is an object of the present invention to provide an apparatus for controlling a vehicle that suppresses a deterioration of the turning performance of the vehicle.

It is an additional object of the present invention to provide an apparatus for controlling a vehicle steering device for providing a steering assist capable of absorbing or canceling turning force caused by a difference between the rotation speed fluctuations on wheels.

An embodiment of the invention provides a vehicle control apparatus for controlling a vehicle, comprises speed signal generating means for generating speed signals corresponding to wheels diagonally placed on the vehicle, discriminating means for discriminating and outputting vibration components on the speed signals from the speed signal generating means, the vibration components having a waveform similar to the sine wave and a cyclic period corresponding to a rotation of the wheels, turn determining means for determining whether the vehicle is in a turning movement or not, and control means for controlling force on steerable wheels in order to control a turning performance of the vehicle, the force being adjusted based on the vibration components discriminated by the discriminating means to have a direction that is the same as a direction of a rotating force on the vehicle caused by the vibration components, when the turning movement of the vehicle is determined by the turn determining means.

The vibration components, i.e., the tire-uniformity components, generated on the wheels placed diagonally on the vehicle affects the turning performance of the vehicle. For example, a difference between the vibration components on the diagonally placed wheels may induce or generate rotating force that rotates the vehicle in the turning direction and in a direction opposite to the turning direction alternately. The rotating force may spoil or deteriorate the turning performance of the vehicle, and may makes a driver uncomfortable since he or she may feel a difference between a rotating amount of a steering wheel and a turning movement of the vehicle. In order to avoid such a disadvantage, the invention adjusts the force on the steerable wheels to reduce or cancel the rotating force induced by the vibration components.

In the other example, in case that the vibration components generate the rotating force in the turning direction, it is difficult to utilize the rotating force to promote an actual turning movement of the vehicle while keeping the steering angle constant. In case that the vibration components generate the rotating force opposite to the turning direction, it may be difficult to ensure a smooth turning movement the vehicle while keeping the steering angle constant.

In one embodiment of the invention, the control means supplies turn compensational force on the steerable wheels. The turn compensational force slightly modulates the steering force that always acting in the turning direction to keeps the orientation of the steerable wheels. The turn compensational force is alternately adjusted or modulated in accordance with the direction of the rotating force generated by the vibration components. For example, the control means supplies the turn compensational force in the turning direction, when the rotating force acts in the turning direction. The turn compensational force in the turning direction makes the steerable wheels easy to change orientations in the turning direction in response to the rotating force generated by the vibration force, and improves the turning performance. The control means supplies the turn compensational force in the direction opposite to the turning direction. The turn compensational force in the opposite direction to the turning direction makes the steerable wheels easy to change orientations in a direction opposite to the turning direction in response to the rotating force generated by the vibration force, and ensure a smooth movement of the vehicle. As a result, if the vehicle receives the rotating force generated by the vibration components on the diagonally placed wheels, it is possible to suppress or avoid spoiling or deterioration of the turning performance of the vehicle.

The vehicle control apparatus may be a component of an electric power steering system which is adapted to supply force on the steerable wheels in order to assist a manipulation on a steering wheel. According to the embodiment, it is possible to change the steering force by using a controlling function that is installed in the electric power steering system.

The electric power steering system may have calculating means for calculating a fundamental assist force based on a vehicle speed and rotating force on the steering wheel, and the control means adjusts the force by correcting the fundamental assist force based on at least a phase difference between the vibration components generated on the wheels diagonally placed on the vehicle, when the vehicle is in the turning movement. According to the embodiment, it is possible to ensure the turning performance while maintaining an assisting function of the electric power steering system.

The control means may adjust the force, when the phase difference between the vibration components generated on the wheels diagonally placed on the vehicle is greater than a predetermined value.

The control means may adjust the force based on the vibration component generated on an outside front wheel that is one of the front wheels placed on an outside of the turning movement and the vibration component generated on an inside rear wheel that is one of the rear wheels placed on an inside of the turning movement.

The control means may increasingly correct the fundamental assist force by an increasing amount so as to act greater assist force than the fundamental assist force in a steering direction, when the vibration component generated on the outside front wheel is greater than the vibration component generated on the inside rear wheel.

The control means may increase the increasing amount, as the vibration component generated on the outside front wheel becomes greater than the vibration component generated on the inside rear wheel.

The control means may decreasingly correct the fundamental assist force by a decreasing amount so as to act smaller assist force than the fundamental assist force in a steering direction, when the vibration component generated on the outside front wheel is smaller than the vibration component generated on the inside rear wheel.

The control means may increase the decreasing amount, as the vibration component generated on the outside front wheel becomes smaller than the vibration component generated on the inside rear wheel.

### BRIEF DESCRIPTION OF THE DRAWINGS

Additional objects and advantages of the present invention will be more readily apparent from the following detailed description of preferred embodiments when taken together with the accompanying drawings. In which:

FIG. 1 is a block diagram showing a vehicle control apparatus according to a first embodiment of the invention;

FIG. 2 is a block diagram showing processes performed by a controller according to the first embodiment;

FIG. 3 is a flowchart showing processes performed by the apparatus according to the first embodiment;

FIGS. 4A, 4B and 4C are graphs showing tire-uniformity components and a gain in an anti-phase relation according to the first embodiment; and

FIGS. 5A and 5B are graphs showing maps for determining the gain in an in-phase relation and an anti-phase relation according to the first embodiment.

### DETAILED DESCRIPTION OF THE PREFERRED EMBODIMENTS

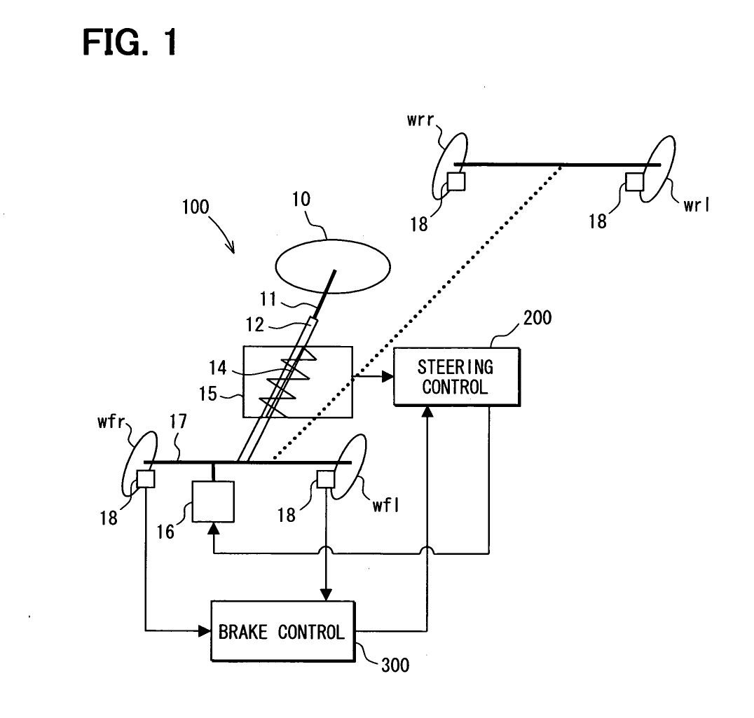

A first embodiment of the invention is described below with the drawings. Referring to FIG. 1, a vehicle control apparatus 100 is provided as an electric power steering system. In other words, the vehicle control apparatus 100 is installed as a component of the electric power steering system. The vehicle control apparatus 100 supplies a turn compensational force on a steerable wheel such as a front wheel by using an adjusting function of a wheel control apparatus. The turn compensational force is supplied by adjusting an assist torque of the electric power steering system. The electric power steering system enables the vehicle control system 100 to supply precisely controlled force on the steerable wheels.

The vehicle control apparatus 100 includes ordinary components for the electric power steering system, such as a steering wheel 10, a steering shaft 11, a pinion shaft 12, a motor 16 for generating the assist torque, a rack shaft 17, and a controller 200.

The controller 200 performs several control functions including a steering assist control and a turn control by controlling the motor 16 based on signals from a plurality of sensors. In the steering assist control, the controller 200 generates an assist torque in response to a steering action of a driver. In the turn control, the controller 200 controls the motor 16 to suppress a deterioration of a turning performance of the vehicle by supplying the turn compensational force on the steerable wheels, when the tire-uniformity components of an outside front wheel and an inside rear wheel generate forces in a rotating direction of the vehicle. The turn compensational force is set to cancel or reduce the rotating force generated by the tire-uniformity components.

The steering wheel 10 is connected with an end of the steering shaft 11. The other end of the steering shaft 11 is coupled to the pinion shaft 12 so that the steering shaft 11 and the pinion shaft 12 are rotated together. The pinion shaft 12 has an input shaft and an output shaft. A torque sensor 15 is disposed between the input shaft and the output shaft.

The pinion shaft 12 has a pinion gear on the end of the output shaft. The pinion gear engaged with a rack gear formed on the rack shaft 17. The rack shaft 17 has both ends to which the steerable wheels operatively coupled respectively. The rack shaft 17 is coupled with the steerable wheels via tie-rods and knuckle arms. The steerable wheels are a front right wheel wfr and a front left wheel wfl. Therefore, the front wheels wfr and wfl are steered as the steering wheel 10 is rotated by the driver through a well known rack and pinion mechanism. When the vehicle is turning right, the front left wheel wfl is placed as an outside front wheel, and the rear right wheel wrr is placed as an inside rear wheel. When the vehicle is turning left, the front right wheel wfr is placed as an outside front wheel, and the rear left wheel wrl is placed as an inside rear wheel. Therefore, two wheels placed diagonally out of four wheels on the vehicle are complementarily called as the outside front wheel and the inside rear wheel.

The torque sensor 15 includes a torsion bar 14. The torsion bar 14 engages the input shaft and the output shaft in the pinion shaft 12. Therefore, a rotating force applied on the steering wheel 10 makes the torsion bar 14 twisted to enable a relative rotation between the input shaft and the output shaft in a certain rotating angle corresponding to a rotating torque applied on the steering wheel 10 by the driver. The torque sensor 15 generates a signal proportion to the rotating torque in response to the rotating angle, and submits the signal to the controller 200. The other type of known torque sensors can be used alternatively.

The motor 16 has a rack and pinion mechanism that couples an output shaft of the motor 16 and a rack shaft 17. An assist torque generated by the motor 16 can be transmitted to the rack shaft 17, and assists a steering manipulation of the driver. Each of the steerable wheels receives a steering force composed of a drive's manipulation force and an assist force supplied by the electric power steering system.

A wheel speed sensor 18 is provided on the front right wheel wfr. Similarly, a wheel speed sensor 18 is provided on the front left wheel wfl. A wheel speed sensor 18 is provided on the rear right wheel wrr. A wheel speed sensor 18 is provided on the rear left wheel wrl. The wheel speed sensors 18 provides speed signal generating means for generating speed signals corresponding to each one of the wheels. The wheel speed sensor 18 has a rotor rotating with the wheel and a pick-up coil electromagnetically coupled with the rotor. The rotor is made of a magnetic material formed in a disc shape with a plurality of teeth. The pick-up coil is placed adjacent to the rotor and to face the teeth to detect changing magnetic field as the rotor rotates. The pick-up coil outputs an alternating signal indicative of a rotation speed. The signals from the wheel speed sensors 18 are input into the brake control device 300. The brake control device 300 performs processing for detecting and calculating rotation speeds, and tire-uniformity components. The tire-uniformity components can be also recognized as vibration components on the signal of the rotation speed. The rotation speeds and the tire-uniformity components may be calculated by the controller 200 instead.

The brake control device 300 processes the output signals from the wheel speed sensors 18 into pulse signals by a circuit for shaping wave form. Then, the brake control device 300 calculates a rotation speed based on time periods between pulses on the pulse signal. Further, the brake control device 300 calculates a tire-uniformity component based on the rotation speed. The tire-uniformity component is a vibration component like a sine wave on the rotation speed during one rotation of the wheel. The tire-uniformity component has a cyclic period corresponding to a rotation of the wheel. The brake control device 300 calculates a vehicle speed based on a plurality of rotation speeds of the wheels. Then, the brake control device 300 outputs the vehicle speed and the tire-uniformity components to the controller 200.

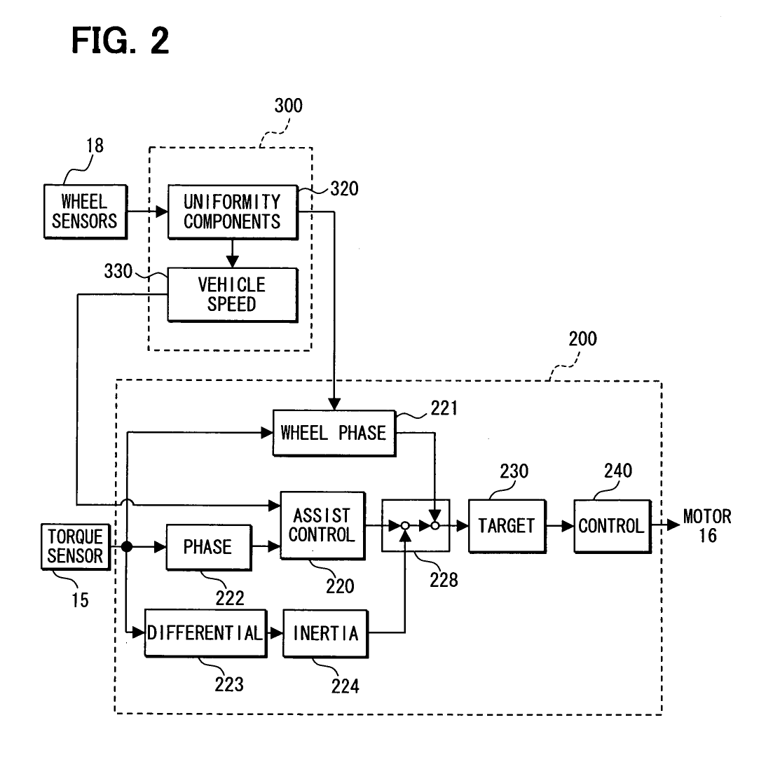

Referring to FIG. 2, the controller 200 and the brake control device 300 provides functional blocks to perform the steering assist control and the vibration suppressing control.

The brake control device 300 has a tire-uniformity component calculating block 320 for calculating the tire-uniformity components of each wheels wfr, wfl, wrr and wrl. The block 320 provides discriminating means for discriminating and outputting vibration components on the speed signals. The block 320 discriminates the vibration components having a waveform similar to the sine wave and a cyclic period corresponding to a rotation of the wheels. The brake control device 300 has a vehicle speed calculating block 330 for calculating the vehicle speed based on the rotation speeds of the wheels by eliminating noise such as a slip component. The tire-uniformity components are output to a wheel phase control block 221 in the controller 200. The vehicle speed is output to an assist control block 220 in the controller 200. The torque sensor 15 detects the rotating torque on the steering wheel 10. The rotating torque is delivered to a wheel phase control block 221, a phase compensation block 222 and a differential block 223.

The wheel phase control block 221 calculates a correcting torque based on the tire-uniformity components and the rotating torque. The correcting torque is designed to correct the assist torque that is calculated by the other blocks such as the assist control block 220. The correcting torque is added with the other signals in an adding block 228 to provide a target assist torque.

The phase compensation block 222 performs phase compensation to the rotating torque detected by the torque sensor 15, and output it to the assist control block 220. The assist control block 220 calculates an assist torque based on the vehicle speed and the rotating torque. The assist control block 220 may have a predetermined characteristic that obtains the assist torque based on the vehicle speed and the rotating torque compensated in the phase compensation block 222.

The differential block 223 calculates a differential value of the rotating torque, and output it to the inertia compensation block 224. An Inertia compensation block 224 calculates an inertia compensational torque based on the differential value of the rotating torque. The inertia compensation block 224 may have a predetermined characteristic that obtains the inertia compensational torque based on the differential value of the rotating torque. The inertia compensational torque is added with the other signals in the adding block 228 to provide the target assist torque.

The adding block 228 calculates the target assist torque by summing the assist torque calculated by the assist control block 220, the correcting torque calculated by the wheel phase control block 221, and the inertia compensational torque calculated by the inertia compensation block 224. The adding block 228 outputs the target assist torque to a target current calculating block 230. The target current calculating block 230 calculates a target current Iq based on the target assist torque and outputs the target current Iq. The target current Iq is calculated so that the motor 16 generates an actual assist torque corresponding to the target assist torque. The target current Iq is supplied to a current control block 240. The current control block 240 controls an actual current flowing through the motor 16. The current control block 240 makes the actual current equal to the target current Iq. The current control block 240 may perform a feedback control.

The values calculated in each blocks may have the other dimensions such as current or coefficient. For example, the wheel phase control block 221 may calculate a correcting current. In this case, the correcting current is supplied to the target current calculating block 230. The correcting current may be directly added to a current value calculated based on the assist torque and the inertia compensational torque. As a result, it is possible to achieve the target current Iq similar to the above description. Alternatively, the wheel phase control block 221 may calculates a correcting coefficient. In this case, the correcting coefficient may be obtained to at least one of the adding block 228 and the target current calculating block 230. The adding block 228 and the target current calculating block 230 may apply the correcting coefficient to the output value. As a result, it is possible to achieve the target assist torque and the target current Iq similar to the above description.

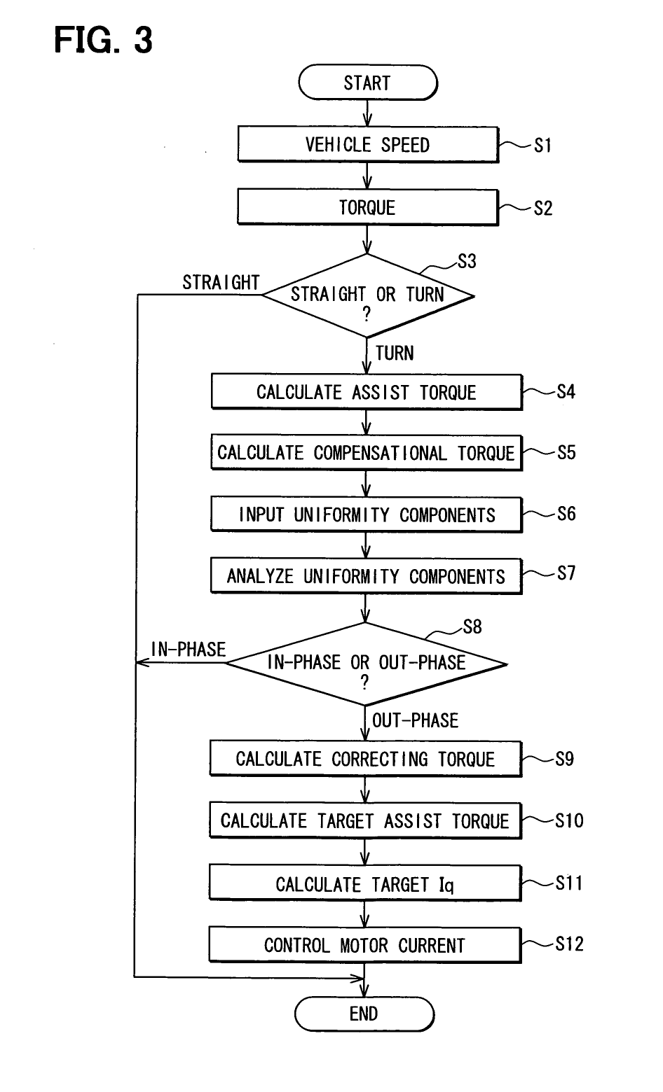

Referring to FIG. 3, the controller 200 performs the following processes.

The controller 200 starts the flowchart in response to a turning on of a vehicle power switch such as an ignition switch. In a step S1, the controller 200 inputs the vehicle speed from the brake control device 300. In a step S2, the controller 200 detects and calculates the rotating torque based on the signal from the torque sensor 15. The rotating torque indicates a torque applied on the steering wheel 10 by the driver. In the step S2, a phase compensation process for the rotating torque is performed simultaneously.

In a step S3, driving condition of the vehicle is determined based on signals from sensors. The controller 200 determines whether the vehicle is in a straight movement or in a turning movement based on the rotating torque detected in the step S2. For example, it is possible to determine the vehicle is in the straight movement when the rotating torque is zero or smaller than a threshold value. It is possible to determine the vehicle is in the turning movement when the rotating torque is greater than a threshold value. The controller 200 further determines whether the vehicle is in a right turning or a left turning. The controller 200 may determines whether the straight movement or the turning movement based on a difference between the rotation speeds of the wheels. In addition, the other sensors such as a rotating angle sensor for detecting a rotating angle of the steering wheel 10 can be used. In case that the vehicle is in the straight movement, the controller 200 jumps the following process and complete the flowchart. In case that the vehicle is in the turning movement, the controller 200 advances the process to a step S4. The step S3 provides turn determining means for determining whether the vehicle is in a turning movement or not.

In the step S4, the assist torque is calculated base on the vehicle speed and the rotating torque. In this calculation, a predetermined characteristic such as a predetermined functional expression is used. In a step S5, the differential value of the rotating torque is calculated. In the step S5, the inertia compensational torque is also calculated based on the differential value. In this calculation, a predetermined characteristic such as a predetermined functional expression is used. The inertia compensational torque is introduced in the embodiment to compensate variable components relating to the inertia.

In a step S6, the tire-uniformity components on the wheels are retrieved from the brake control device 300. The method for calculating the tire-uniformity component is briefly described below, but is also described in the other documents such as JP-A-H08-132831.

The signals from the wheel speed sensors 18 are processed into a pulse signal maintaining cyclic periods. Then, time periods Δtn between pulses are measured. Here, n indicates a number of samples. Since a plurality of pulses are generated during a rotation of the wheel, a plurality of time periods Δt1, Δt2, Δt3-ΔtN are measured during a rotation of the wheel. A mean time period ΔtM for a rotation of the wheel is calculated by an expression,

(Σ Δtn)/N=ΔtM.

Here, N is a number of samples. The symbol Σ means a summation from n=1 to n=N corresponding to a group of samples detected during a rotation of the wheel. Then, a value Δθ(n) is calculated by an expression 1,

Δθ(n)=Δtn/ΔtM.

The value Δθ(n) includes a tire-uniformity component Δθu(n) and an error data Δθr(n). The error data Δθr(n) indicates a manufacturing error of the rotor.

In the above expression 1, each of the time periods Δtn is divided by the mean time period ΔtM. The time period Δtn indicates a time where the wheel rotates a predetermined rotation angle corresponding to an angle between two adjacent teeth on the rotor. The mean time period ΔtM is an average time of the time periods Δtn for a rotation of the wheel. As a result, the value Δθ(n) means a ratio that indicates a fluctuation of each time period Δtn to the mean time period ΔtM.

The value Δθ(n) may be replaceable with a value Δθ′(n) which can be obtained by an expression 2,

Δθ′(n)=(Σ Δθ(n)k)/M.

Here, k is a number of samples. The symbol Σ means a summation from k=1 to k=M. In the expression 2, the ratio indicating a fluctuation of the time period Δtn to the mean time period ΔtM is obtained as a mean value for M times. Here, M is rotations of the wheel.

In the case of expression 2, it is possible to increase accuracy of the ratio Δθ′(n), but more time is necessary to achieve the ratio Δθ′(n). In other words, the wheel must rotates M times to obtain the ratio Δθ′(n).

The error data Δθr(n) is obtained beforehand by measuring an amount of manufacturing error of the rotor. The error data Δθr(n) is stored in a memory device in the brake control device 300. The error data Δθr(n) is a ratio of a rotation angle obtained by an expression 3,

Δθr(n)=θn/(2n/N).

In expression 3, a rotation angle of each teeth θn is divided by a mean rotation angle of teeth (2n/N).

Then, the tire-uniformity component Δθu(n) is obtained by an expression 4,

Δθu(n)=(Δθ(n)−1)−(Δθr(n)−1).

In the expression 4, the tire-uniformity component Δθu(n) is obtained by subtracting the error data Δθr(n) from the ratio Δθ(n).

In the expression 4, 1 is subtracted from the ratio Δθ(n), since the ratio is calculated as a ratio with respect to a reference value. Because of the similar reason, 1 is also subtracted from the error data Δθr(n).

In stead of preparing and subtracting the error data Δθr(n), the tire-uniformity component Δθu(n) can be obtained by applying digital filter technique that removes high frequency components corresponding to a manufacturing error of the rotor. For example, a low pass filter such as the second-order Butterworth low pass filter can be used to process the ratio Δθ(n) for this purpose.

In a step S7, the controller 200 analyzes and calculates a phase difference and a value of composite level of the tire-uniformity components of the outside front wheel and the inside rear wheel. The tire-uniformity components generated on the wheels placed in a diagonal relation on the vehicle generate rotating force acting on the vehicle body in a rotating direction. The rotating force is varied in accordance with the phase difference and the composite level of the tire-uniformity components generated on the wheels placed in the diagonal relation. Hereinafter, two wheels in the diagonal relations are called as a diagonal pair of wheels.

The phase difference is obtained by analyzing the tire-uniformity components of the diagonal pair of wheels that includes the tire-uniformity component of the outside front wheel and the tire-uniformity component of the inside rear wheel. The phase difference may be called as a phase relation such as the in-phase relation and the anti-phase relation. The phase difference is obtained in order to identify modes of the rotating force. In the first mode, in the anti-phase relation, the rotating force acts an inside direction or an outside direction with respect to the turning movement of the vehicle in accordance with a difference between the tire-uniformity components. In the second mode, in the in-phase relation, the rotating force appears relatively small that is possible to be ignored.

The composite level may be called as a level difference between the tire-uniformity components of the diagonal pair of wheels that includes the tire-uniformity component of the outside front wheel and the tire-uniformity component of the inside rear wheel. The composite level is a value obtained based on an instantaneous level of the tire-uniformity component of the outside front wheel and an instantaneous level of the tire-uniformity component of the inside rear wheel. The composite level is obtained as a difference between the instantaneous levels of the tire-uniformity components in the anti-phase relation. The composite level is obtained in order to indicate at least magnitude of the rotating force generated by the tire-uniformity components.

In case of four wheel vehicle, it is preferable to select the diagonal pair of wheels including the outside front wheel and the inside rear wheel. The outside front wheel supports relatively heavy weight, when the vehicle is in the turning movement. Therefore, the outside front wheel largely influences the turning movement of the vehicle. In addition, the tire-uniformity components of the diagonal pair of wheels including the outside front wheel largely influence the turning movement of the vehicle. Hereinafter, the diagonal pair of wheels having the outside front wheel is called as a dominant pair of wheels. Therefore, in step S6, the tire-uniformity components of the dominant pair of wheels are retrieved in accordance with the turning directions. For example, in case of the right turn, the tire-uniformity component of the front left wheel and the tire-uniformity component of the rear right wheel are retrieved. In case of the left turning, the tire-uniformity component of the front right wheel and the tire-uniformity component of the rear left wheel are retrieved.

For example, in case that the phase difference can be considered as the anti-phase relation since the wave forms of the tire-uniformity components of the dominant pair of wheels are shifted out of a certain range such as 1/4 cyclic period, and the composite level indicates that the tire-uniformity component of the outside front wheel is greater than that of the inside rear wheel, then the rotating force acts toward the turning direction.

In case that the phase difference can be considered as the anti-phase relation since the wave forms of the tire-uniformity components of the dominant pair of wheels are shifted out of the range of 1/4 cyclic period, and the composite level indicates that the tire-uniformity component of the outside front wheel is smaller than that of the inside rear wheel, then the rotating force acts toward opposite to the turning direction.

In case that the phase difference can be considered as the in-phase relation since the wave forms of the tire-uniformity components of the dominant pair of wheels are shifted within the certain range such as 1/4 cyclic period, the rotating force takes small amount that is hardly influence the vehicle movement. Therefore, in the in-phase relation, the rotating force generated by the tire-uniformity components of the dominant pair of wheels is small enough to be ignored.

As described above, the vehicle body receives the rotating force. The rotating force changes its direction and magnitude in response to the cyclic period, the phase difference and the levels of the tire-uniformity components of the dominant pair of wheels. The rotating force may spoil or deteriorate the turning performance of the vehicle.

In step S8, the controller 200 determines the phase difference of the tire-uniformity components of the dominant pair of wheels. The phase difference is the phase relation indicative of the anti-phase relation or the in-phase relation. In step S8, it is determined that whether the tire-uniformity components of the dominant pair of wheels are in the anti-phase relation or the in-phase relation. In case of the in-phase relation, the controller 200 jumps the following process and completes the flowchart. In case of the anti-phase relation, the controller 200 advances the process to a step S9.

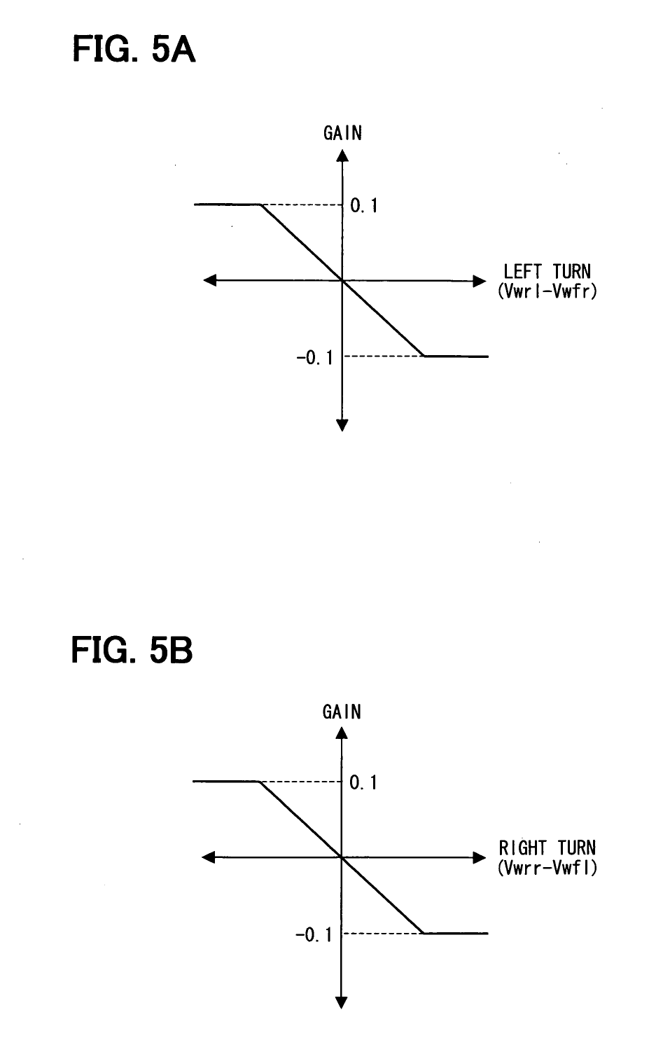

In a step S9, the controller 200 calculates the correcting torque based on the phase difference and the composite level. The correcting torque may be obtained by looking up a predetermined map having parameters at least including the phase difference and the composite level. The controller 200 calculates and determines the correcting torque by using the maps shown in FIGS. 5A and 5B. The controller 200 selects one of the maps in accordance with the phase difference. Then, the controller 200 calculates and determines the correcting torque based on the map and the composed level of the tire-uniformity components of the dominant pair of wheels. The maps shown in FIGS. 5A and 5B obtains a gain for determining the correcting torque. The correcting torque is calculated and determined to supply the turn compensational force on the steerable wheels in a steering direction that is the same as a direction of the rotating force caused by the tire-uniformity components on the dominant pair of wheels.

In a step S10, the controller 200 sums the correcting torque, the assist torque and the inertia compensational torque in order to obtain a target assist torque. The step S10 provides a correcting function in which a fundamental assist torque is corrected by the correcting torque. The sum of the assist torque and the inertia compensational torque obtains the fundamental assist torque. Therefore, it is possible to perform both the steering assist control and the turn control simultaneously. In the steering assist control the driver's manipulating force on the steering wheel 10 is assisted by adding assist torque. In the turn control, a deterioration of the turning performance of the vehicle is suppressed by adjusting the assist torque acting in the steering direction in response to the tire-uniformity components of the dominant pair of wheels.

In a step S11, the controller 200 calculates a target current Iq based on the target assist torque calculated in the step S10. In a step S12, the controller 200 performs a current control in which a current supplied to the motor 16 is adjusted to the target current Iq.

The controller 200 repeats the process described above for every predetermined processing period, e.g., 12 ms. The controller 200 terminates the processing in response to a turning off of the ignition switch.

The steps S4 through S12 provides control means for controlling turn compensational force on the steerable wheels in order to maintain or improve the turning performance of the vehicle. The turn compensational force is adjusted based on the vibration components such as the tire-uniformity components discriminated by the block 320. The turn compensational force is adjusted and modulated to have a direction that is the same as a direction of the rotating force on the vehicle caused by the vibration components. The control means controls the turn compensational force when the turning movement of the vehicle is determined by the turn determining means.

A method for calculating and determining the correcting torque is described below. In the following description, in order to make simplify the description and help understanding, the method is described under conditions where the phase relation is in a perfect in-phase relation and a perfect anti-phase relation. However, it is understood that the idea and method described below can be applied similarly to the other conditions, e.g., in a middle condition while the phase relation is being shifted between the in-phase relation and the anti-phase relation.

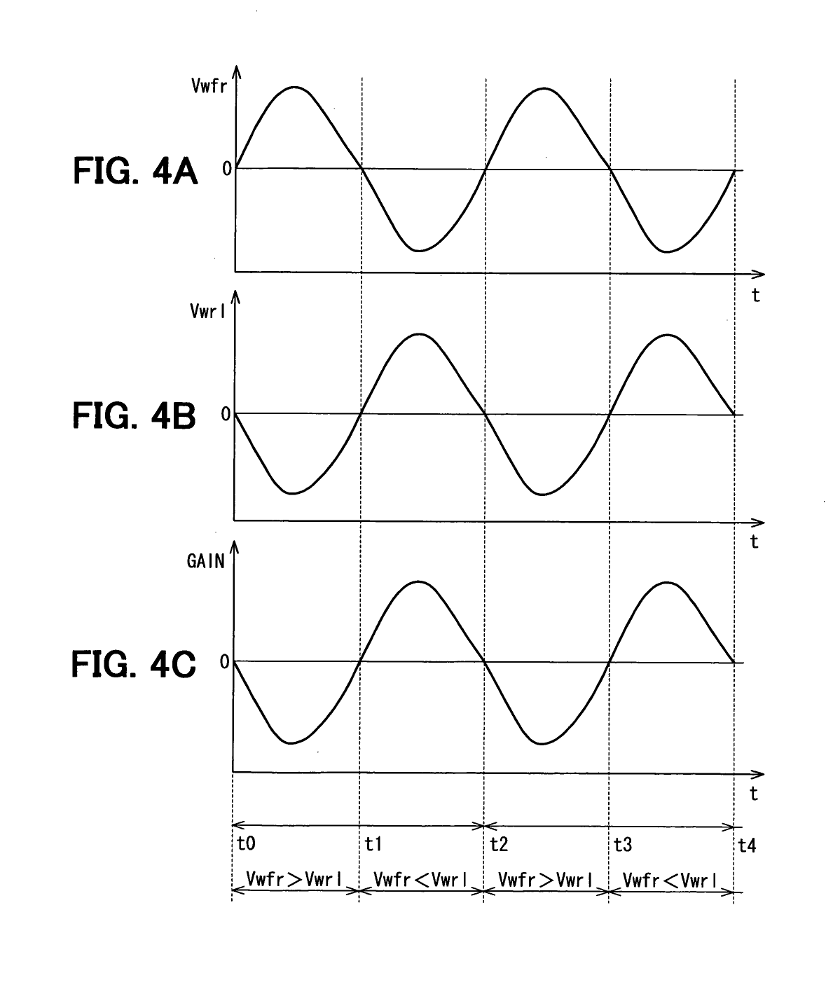

FIGS. 4A, 4B and 4C show the tire-uniformity components of the dominant pair of wheels and a gain for calculating the correcting torque when the phase relation is the anti-phase relation while the vehicle is in the turning movement. More specifically, FIGS. 4A, 4B and 4C show the left turn. Therefore, FIG. 4A shows the tire-uniformity component Vwfr of the front right wheel wfr as the outside front wheel. FIG. 4B shows the tire-uniformity component Vwrl of the rear left wheel wrl as an inside rear wheel. FIG. 4C shows level of the gain for determining the correcting torque. The correcting torque is obtained by applying the gain to the rotating torque detected by the torque sensor 15. Therefore, the gain mutually related to the correcting torque.

In case that the tire-uniformity components Vwfr and Vwrl shown in FIGS. 4A and 4B are calculated in the brake control device 300, the controller 200 determines that the tire-uniformity components Vwfr and Vwrl are in the anti-phase relation, since the tire-uniformity components Vwfr and Vwrl are shifted greater than a predetermined phase, e.g., 1/4 cyclic period. The controller 200 has a memory device for storing the maps for determining the gain in the anti-phase relation.

FIG. 5A shows one example of the map for determining the gain in the left turn. FIG. 5B shows one example of the map for determining the gain in the right turn. Those maps may be consolidated into a single map by making the horizontal axis interchangeable between (Vwrl−Vwfr) and (Vwrr−Vwfl).

Referring to FIGS. 4A, 4B and 4C, the tire-uniformity component Vwfr of the outside front wheel wfr is greater than the tire-uniformity component Vwrl of the inside rear wheel wrl at a period of time between a time t0 and a time t1, and a period of time between a time t2 and a time t3.

When the tire-uniformity component Vwfr of the outside front wheel wfr is greater than the tire-uniformity component Vwrl of the inside rear wheel wrl, the composite level of the tire-uniformity components Vwfr and Vwrl generates the rotating force acting on the vehicle in a direction that promotes the turning movement of the vehicle. In such a condition, if the electric power steering device supplies a fundamental assist torque calculated based on the rotating torque onto the front wheels, it is difficult to take advantage of the turn promoting force for turning the vehicle.

In order to avoid such a disadvantage, the controller 200 obtains positive value for the gain at the period of time between the time t0 and the time t1, and the period of time between the time t2 and the time t3, as shown in FIG. 4C. The gain having positive value increasingly corrects the fundamental assist torque. Therefore, the electric power steering device supplies greater assist torque that is greater than the fundamental assist torque by an increasing amount. Such a greater assist torque enables the front wheels to easily change its orientation toward the turning movement of the vehicle. Therefore, the vehicle, the steering system, is controlled in a condition that promotes the turning movement. It is possible to improve the turning performance of the vehicle.

On the other hand, the tire-uniformity component Vwfr of the outside front wheel wfr is smaller than the tire-uniformity component Vwrl of the inside rear wheel wrl at a period of time between a time t1 and a time t2, and a period of time between a time t3 and a time t4.

When the tire-uniformity component Vwfr of the outside front wheel wfr is smaller than the tire-uniformity component Vwrl of the inside rear wheel wrl, the composite level of the tire-uniformity components Vwfr and Vwrl generates the rotating force acting on the vehicle in a direction that prevents the turning movement of the vehicle. In such a condition, if the electric power steering device supplies a fundamental assist torque calculated based on the rotating torque onto the front wheels and the wheels are maintained in a steering angle for turning the vehicle, the vehicle may not demonstrate a smooth and desired turning movement.

In order to avoid such a disadvantage, the controller 200 obtains negative value for the gain at the period of time between the time t1 and the time t2, and the period of time between the time t3 and the time t4, as shown in FIG. 4C. The gain having negative value decreasingly corrects the fundamental assist torque. Therefore, the electric power steering device supplies smaller assist torque that is smaller than the fundamental assist torque by a decreasing amount. Such a smaller assist torque enables the front wheels to easily change its orientation toward an opposite side to the turning movement of the vehicle. Therefore, it is possible to keep smooth movement while doing the turning movement.

As shown in FIG. 4C, the gain is determined to have magnitude in accordance with the composite level of the tire-uniformity components Vwfr and Vwrl. The gain becomes greater in the positive, as the tire-uniformity component Vwfr of the outside front wheel wfr becomes greater with respect to the tire-uniformity component Vwrl of the inside rear wheel wrl. As the difference (Vwrl−Vwfr) becomes greater in the negative, the gain is increased to have a greater absolute value in the positive. In other words, the controller 200 increases the increasing amount, as the vibration component generated on the outside front wheel becomes greater than the vibration component generated on the inside rear wheel. Such a characteristic is required because the rotating force in the turn promoting direction becomes greater, as the tire-uniformity component Vwfr of the outside front wheel wfr becomes greater with respect to the tire-uniformity component Vwrl of the inside rear wheel wrl.

The gain becomes greater in the negative, as the tire-uniformity component Vwfr of the outside front wheel wfr becomes smaller with respect to the tire-uniformity component Vwrl of the inside rear wheel wrl. As the difference (Vwrl−Vwfr) becomes greater in the positive, the gain is decreased to have the greater absolute value in the negative. In other words, the controller 200 increases the decreasing amount, as the tire-uniformity component generated on the outside front wheel becomes smaller with respect to the tire-uniformity component generated on the inside front wheel. Such a characteristic is required because the rotating force in the turn preventing direction becomes greater, as the tire-uniformity component Vwfr of the outside front wheel wfr becomes smaller with respect to the tire-uniformity component Vwrl of the outside front wheel wrl.

In order to change the gain in accordance with the composite level of the tire-uniformity components of the dominant pair of wheels in the above described fashion, the map has a characteristic shown in FIGS. 5A and 5B. The map has a variable (Vwrl−Vwfr) or (Vwrr−Vwfl), which is a result of subtracting the tire-uniformity component of the outside front wheel from the tire-uniformity component of the inside rear wheel. The gain gradually becomes greater in the negative, as the result of the subtraction becomes greater from zero. In contrast, the gain gradually becomes greater in the positive, as the result of the subtraction becomes smaller from zero. The gain is set in a reverse proportional fashion with respect to the composite level. The gain can be changed within a predetermined range having maximum values on both sides, e.g., a negative maximum value is −0.1, and a positive maximum value is +0.1.

Although the present invention has been fully described in connection with the preferred embodiments thereof with reference to the accompanying drawings, it is to be noted that various changes and modifications will become apparent to those skilled in the art. Such changes and modifications are to be understood as being within the scope of the present invention as defined by the appended claims.

For example, although the above described embodiment uses the outside front wheel and the inside rear wheel as the dominant pair of wheels, it is possible to use the inside front wheel and the outside rear wheel as the dominant pair of the wheels.

Although the above described embodiment calculates the correcting torque in response to the determination of the anti-phase relation in the determining process of the phase relation, it is possible to calculate the correcting torque based on the composite level of the tire-uniformity components of the diagonal pair of wheels when the composite level of the tire-uniformity components of the diagonal pair of wheels reaches a predetermined level, e.g., the difference between the tire-uniformity components of the diagonal pair of wheels exceeds a predetermined level.

For example, although the above described embodiment uses the torque to be generated by the motor as a variable calculated in the blocks 220, 221, and 224 in the controller 200, it is possible to use a current value corresponding to the torque in those blocks.

What is claimed is:

1. A vehicle control apparatus for controlling a vehicle, comprising:
speed signal generating means for generating speed signals corresponding to wheels diagonally placed on the vehicle;
discriminating means for discriminating and outputting vibration components on the speed signals from the speed signal generating means, the vibration components having a waveform similar to the sine wave and a cyclic period corresponding to a rotation of the wheels;
turn determining means for determining whether the vehicle is in a turning movement or not; and
control means for controlling force on steerable wheels in order to control a turning performance of the vehicle, the force being adjusted based on the vibration components discriminated by the discriminating means to have a direction that is the same as a direction of a rotating force on the vehicle caused by the vibration components, when the turning movement of the vehicle is determined by the turn determining means.

2. The vehicle control apparatus claimed in claim 1, wherein the vehicle control apparatus is a component of an electric power steering system which is adapted to supply force on the steerable wheels in order to assist a manipulation on a steering wheel.

3. The vehicle control apparatus claimed in claim 2, wherein
the electric power steering system has calculating means for calculating a fundamental assist force based on a vehicle speed and rotating force on the steering wheel, and
the control means adjusts the force by correcting the fundamental assist force based on at least a phase difference between the vibration components generated on the wheels diagonally placed on the vehicle, when the vehicle is in the turning movement.

4. The vehicle control apparatus claimed in claim 3, wherein
the control means adjust the force, when the phase difference between the vibration components generated on the wheels diagonally placed on the vehicle is greater than a predetermined value.

5. The vehicle control apparatus claimed in claim 4, wherein
the control means adjust the force based on the vibration component generated on an outside front wheel that is one of the front wheels placed on an outside of the turning movement and the vibration component generated on an inside rear wheel that is one of the rear wheels placed on an inside of the turning movement.

6. The vehicle control apparatus claimed in claim 5, wherein
the control means increasingly corrects the fundamental assist force by an increasing amount so as to act greater assist force than the fundamental assist force in a steering direction, when the vibration component generated on the outside front wheel is greater than the vibration component generated on the inside rear wheel.

7. The vehicle control apparatus claimed in claim 6, wherein
the control means increases the increasing amount, as the vibration component generated on the outside front wheel becomes greater than the vibration component generated on the inside rear wheel.

8. The vehicle control apparatus claimed in claim 5, wherein
the control means decreasingly corrects the fundamental assist force by a decreasing amount so as to act smaller assist force than the fundamental assist force in a steering direction, when the vibration component generated on the outside front wheel is smaller than the vibration component generated on the inside rear wheel.

9. The vehicle control apparatus claimed in claim 8, wherein
the control means increases the decreasing amount, as the vibration component generated on the outside front wheel becomes smaller than the vibration component generated on the inside rear wheel.
